(19) United States
(12) Patent Application Publication
(10) Pub. No.: US 2008/0113627 A1
(43) Pub. Date: May 15, 2008

(54) Regulating Signal Monitoring

(75) Inventors: Laurent Le Faucheur, Antibes (FR); Richard Quinzio, Cagnes-sur-Mer (FR)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/686,537

(22) Filed: Mar. 15, 2007

(30) Foreign Application Priority Data
Nov. 10, 2006 (EP) 06291757.0

(51) Int. Cl. H04B 1/40; H04M 1/00

(52) U.S. Cl. 455/75; 455/552.1

(57) ABSTRACT

A system comprising a transceiver and processing logic coupled to the transceiver. The processing logic is configured to determine an activity level of a network associated with the system and, based on the activity level, adjust a frequency with which the processing logic monitors signals broadcast by the network.

### CROSS-REFERENCE TO RELATED APPLICATION

The present application claims priority to EP Application No. 06291757.0, filed on Nov. 10, 2006, hereby incorporated herein by reference.

### BACKGROUND

Mobile communication devices (e.g., cell phones) are battery-operated. A device operating from a battery only has a finite operational time before the battery needs recharging. Further, charging up a mobile communication device battery can be an inconvenient and time-consuming task. For these and other reasons, techniques which enhance battery life are desirable.

### SUMMARY

Accordingly, there are disclosed herein techniques by which power consumption in a mobile device is reduced compared to devices that do not implement these techniques. An illustrative embodiment includes a system comprising a transceiver and processing logic coupled to the transceiver. The processing logic is configured to determine an activity level of a network associated with the system and, based on the activity level, adjust a frequency with which the processing logic monitors signals broadcast by the network.

Another illustrative embodiment includes a method that comprises determining a network activity level for a predetermined period of time, generating and populating a data structure, the data structure cross-references the network activity level with the predetermined period of time, and if the predetermined period of time is associated with a current time, adjusting a frequency with which signals transmitted from a base station are monitored. Adjusting the frequency comprises adjusting said frequency in accordance with the network activity level.

Yet another illustrative embodiment includes a system comprising means for determining an activity level of a network associated with the system, where the network broadcasts signals. The system also comprises means for monitoring the signals at a frequency that is in accordance with the activity level.

### BRIEF DESCRIPTION OF THE DRAWINGS

For a detailed description of exemplary embodiments of the invention, reference will now be made to the accompanying drawings in which:

FIG. 1 shows an illustrative communications network in accordance with embodiments of the invention;

FIG. 2 shows a detailed view of the mobile communication device of FIG. 2, in accordance with preferred embodiments of the invention;

FIG. 3 shows an illustrative data structure populated in accordance with embodiments of the invention; and

FIG. 4 shows a flow diagram of an illustrative method implemented in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Described herein are techniques by which power consumption in electrical devices, such as mobile communication devices (MCD), is reduced compared to devices which do not implement these techniques. The techniques include periodically determining (e.g., every hour, minute, second, etc.) the activity level of a network associated with the MCD. The techniques also include periodically adjusting (e.g., every hour, minute, second, etc.) the rate at which an MCD monitors network signals to be in accordance with the activity level. Although the various embodiments disclosed herein are primarily described in terms of mobile communication devices, the scope of this disclosure is not limited as such. The embodiments disclosed herein may be implemented in any suitable electronic device.

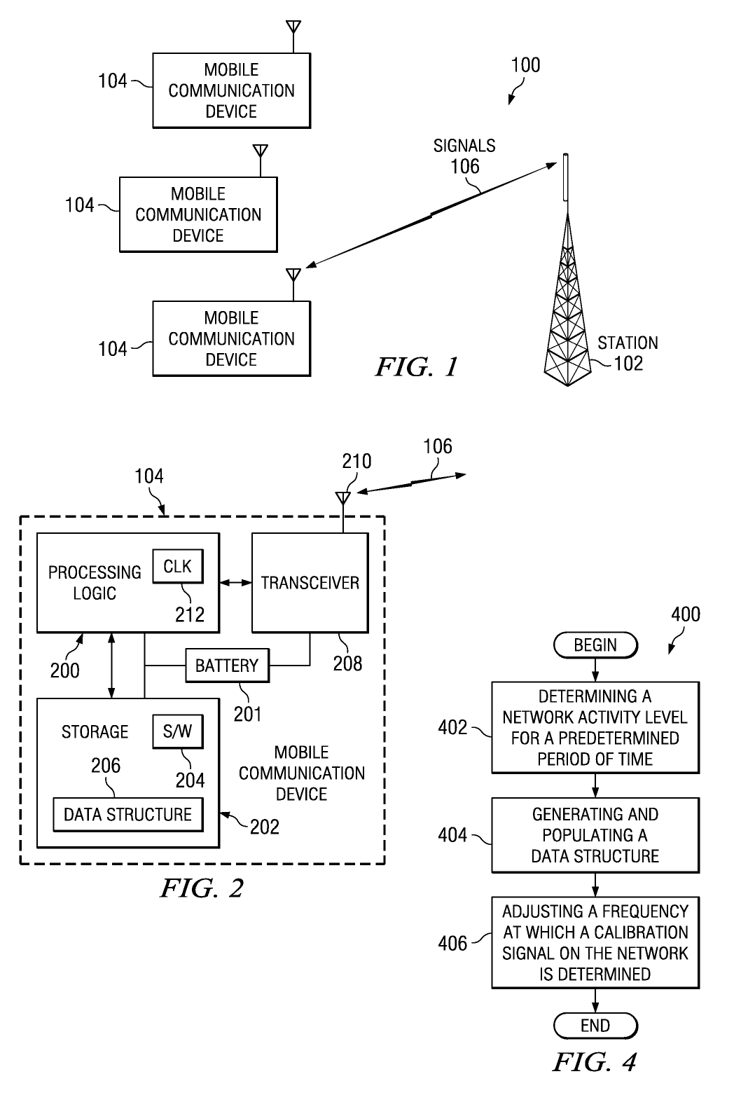

FIG. 1 shows an illustrative communications network 100 comprising a control station (e.g., a cell base station) 102 and an MCD 104. The network 100 may comprise multiple MCDs, and the MCDs may be of different types (e.g., cell phones, personal digital assistants such as the BLACKBERRY®, digital media players such as the iPHONE®). In some embodiments, the network 100 comprises those MCDs 104 with which the control station 102 is able to wirelessly communicate. In at least some embodiments, the network 100 comprises a mobile phone network cell. The network 100 may implement one or more of a variety of communication technologies and/or standards, including the Global System for Mobile Communications (GSM) standard, first generation analog technology, second generation (2 G) digital/personal communication service (PCS) technology or third generation (3 G) technology. The techniques described herein also may be modified as necessary to suit other standards, e.g., fourth generation (4 G) technology, in which internet-protocol (IP) based communications are implemented. All such communications protocols, standards and variations thereof are encompassed within the scope of this disclosure. As represented by numeral 106, the station 102 trades various signals with the MCD 104. Such signals may carry audio and video data as well as information needed by the MCD 104 to establish and/or maintain proper communication with the station 102.

The signals 106 include a Paging Channel (PCH). The station 102 broadcasts paging signals on the PCH when communications need to be established with one of the MCDs. For example, a MCD (or a land-line phone) in a different network (not shown) may initiate a phone call to the MCD 104. The station 102 receives a signal indicating that the MCD in the other network is attempting to establish a phone call with the MCD 104. Accordingly, the station 102 broadcasts on the PCH a paging signal which specifically pages the MCD 104, requesting the MCD 104 to respond by establishing a phone call session with the station 102.

Each of the MCDs in the network 100 regularly monitors the PCH for paging signals (e.g., once every second). Thus, when the station 102 broadcasts the aforementioned paging signal, each of the MCDs in the network 100 will receive the paging signal, even though the paging signal is intended only for the MCD 104. Upon receiving the paging signal, each MCD will determine—using any suitable, established protocol—whether the paging signal was intended for that MCD. In this way, the MCD 104 will determine that the paging signal was intended for the MCD 104, and the remaining MCDs in the network 100 will determine that the paging signal was not intended for those MCDs. Accordingly, the MCD 104 establishes a phone call session with the station 102, and the station 102 (via other network logic) establishes communications between the MCD 104 and the phone in the other network attempting to call the MCD 104.

As explained above, each of the MCDs in the network 100 regularly monitors the PCH for paging signals. Regularly monitoring the PCH in this way may be inefficient and may waste the battery power of the MCD, because the ratio of paging signals monitored by each MCD versus the paging signals actually intended for that MCD is substantially high. Stated otherwise, an MCD may monitor paging signals every second for a long time (e.g., ten hours) without ever receiving a paging signal intended for that MCD. In such a case, the MCD's monitoring of the paging signals unnecessarily consumed power.

Accordingly, to reduce the amount of power consumed by excessive monitoring of the PCH, the MCD 104 monitors network activity levels for a predetermined length of time (e.g., for 24 hours). In some embodiments, the length of time may comprise a rolling time period. In other embodiments, this monitoring of network activity can occur on a regular basis (e.g., once per week, once per month, each time the MCD 104 enters a new network). The MCD 104 logs the network activity levels in, for example, a data structure. The MCD 104 then uses the data structure to adjust future monitoring activity. For example, if the data structure indicates that network activity levels are usually low between 7:00 PM and 5:00 AM everyday, the MCD 104 will reduce its monitoring activity between 7:00 PM and 5:00 AM. By monitoring for paging signals less frequently, the MCD 104 conserves battery power. A MCD 104 which monitors for paging signals less frequently is unlikely to miss an incoming paging signal, since each incoming paging signal preferably is repeated multiple times over a predetermined length of time (e.g., 4 to 8 times over 10 seconds). The number of times the paging signal is repeated, and the length of time over which the paging signal is repeated, are both adjustable as desired.

Network activity levels are considered to be high when a substantial number of calls (e.g., greater than a threshold) are being made to and/or from MCDs in the network, thereby resulting in a substantially high number of paging signals being channeled on the PCH per second. Similarly, network activity levels are considered to be low when fewer calls (e.g., less than a threshold) are being made to and/or from MCDs in the network, thereby resulting in a lower number of paging signals being channeled on the PCH per second.

As explained, after monitoring network activity levels for a predetermined length of time, the MCD 104 generates and populates a data structure that has multiple entries, where each entry cross-references a period of time with a corresponding activity level of the network 100. The MCD 104 then adjusts its own PCH monitoring activity in accordance with the data structure. For example, if the MCD 104 determines that, from 1:00 AM to 5:00 AM, network activity is low and that the rate at which paging signals are being sent on the PCH is thus also low, the MCD 104 may reduce its monitoring activity from 1:00 AM to 5:00 AM. For instance, instead of monitoring the PCH for paging signals every second, the MCD 104 may monitor the PCH for paging signals every two seconds, thereby substantially reducing power consumption during periods of low network activity.

FIG. 2 shows an illustrative block diagram of the MCD 104. The block diagram of FIG. 2 also may be representative of other MCDs in the network 100. The MCD 104 comprises a processing logic 200, a battery 201, a storage 202 comprising software (e.g., firmware) 204 and a data structure 206, a transceiver 208 and an antenna 210. The storage 202 comprises a computer-readable storage medium such as a volatile memory (e.g., random access memory (RAM)), non-volatile memory (e.g., read-only memory (ROM), a hard drive, a CD-ROM) or combinations thereof. The processing logic 200 comprises a clock 212 (e.g., based on a 32 kHz oscillator). The transceiver 208 and the antenna 210 are used to transmit and/or receive signals 106 from the station 102 of FIG. 1. The signals 106 include various information, such as the PCH described above. The signals 106 also may include information not specifically mentioned above. For example, the signals 106 may include a standard network clock signal indicating the date and/or time of day.

In accordance with embodiments of the invention, the software 204 comprises code which, when executed by the processing logic 200, causes the logic 200 to generate and/or populate the data structure 206. To populate the data structure 206, the logic 200 monitors the network activity levels using the signals 106. For example, in some embodiments, the logic 200 may determine the rate at which paging signals are sent on the PCH. The logic 200 then may compare the determined rate against rate thresholds programmed into the storage 202. For example, the storage 202 may comprise two rate thresholds: a low-medium rate threshold and a medium-high rate threshold. If the logic 200 determines that a rate at which paging signals are sent on the PCH falls below the low-medium rate threshold, the logic 200 may determine that the network activity level is “LOW.” If the determined rate falls between the low-medium rate threshold and the medium-high rate threshold, the logic 200 may determine that the network activity level is “MEDIUM.” If the determined rate falls above the medium-high rate threshold, the logic 200 may determine that the network activity level is “HIGH.” In this way, the logic 200 monitors the network activity level for a predetermined amount of time, generates a data structure entry for that amount of time, and populates the data structure entry with an indication as to the network activity level at that time.

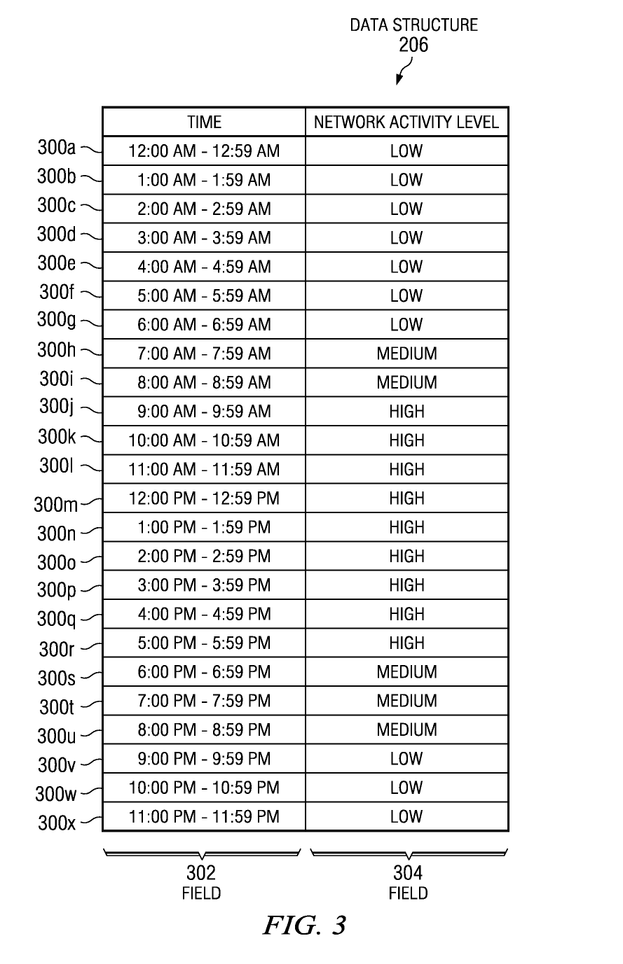

FIG. 3 shows an illustrative data structure 206. The data structure 206 comprises a plurality of entries 300a-300x, although the data structure 206 may comprise any number of entries. Each entry preferably comprises a field 302 and a field 304. The field 304 indicates a network activity level, determined as described above. The field 302 indicates a time period associated with that network activity level. For instance, in the example provided above, the field 302 may contain “1:00 AM-1:59 AM” and the field 304 may contain an indication as to the low network activity level during that period of time.

Although the field 302 preferably comprises data associated with a time period and the field 304 preferably comprises data associated with network activity level, the way in which the fields are populated with these values may vary. For example, the field 302 of one entry may provide a time period in terms of hours (e.g., 1:00 AM-1:59 AM), and the field 302 of another entry may provide a time period in terms of seconds (e.g., 1:00:01 AM-1:59:36 AM). In some embodiments, fields 302 may provide specific times instead of time periods. For example, instead of having a single entry with a field 302 that reads 1:00 AM-1:59 AM, the data structure 206 may have five entries, with the field 302 of the first entry reading 1:00 AM, the field 302 of the second entry reading 2:00 AM, and so on. In some embodiments, instead of having a single entry with a field 302 that reads 1:00 AM-1:59 AM, and instead of having five entries as described above, the data structure 206 may have over 14,000 entries, with the field 302 of the first entry reading 1:00:01 AM, the field 302 of the second entry reading 1:00:02 AM, and so on. The field 302 may list years, months, weeks, days, hours, minutes, seconds, milliseconds, etc. Any and all such permutations suitable for populating one or more data structures 206 are included within the scope of this disclosure. The logic 200 preferably uses either the local 32 kHZ oscillator clock 212 or a network clock provided via signals 106 to populate the fields 302.

The fields 304 of the entries may likewise vary in terms of how they are populated. For example, in some embodiments, a field 304 may contain a numerical value indicating a specific level of network activity. In other embodiments, a field 304 may contain a general indication of the level of network activity, such as “HIGH,” “MEDIUM,” “LOW,” etc. As mentioned, network activity levels may be classified as “HIGH,” “MEDIUM,” “LOW,” etc. in accordance with one or more network activity level thresholds preprogrammed into the software 204. Other techniques for indicating network activity levels besides those explicitly provided herein also fall within the scope of this disclosure.

As explained above, a data structure 206 may be populated in various ways. However, the illustrative data structure 206 shown in FIG. 3 is populated based on a 24-hour system. More specifically, the field 302 of each entry has a time period of one hour, and the field 304 of that entry contains network activity data associated with that hour. Entry 300a indicates that the network activity level is “LOW” from 12:00 AM through 12:59 AM; entry 300b indicates that the network activity level is “LOW” 1:00 AM through 1:59 AM; entry 300c indicates that the network activity level is “LOW” from 2:00 AM through 2:59 AM, and so forth. The data structure 206 of FIG. 3 may be populated by the logic 200 during the 24 hours of any suitable day. In some embodiments, network activity levels may be determined over several days and may be averaged before populating the data structure 206. In this way, the logic 200 collects network activity level data over a predetermined length of time and using any of a variety of monitoring techniques, and the logic 200 populates the data structure 206 using the collected network activity level data.

After the data structure 206 has been populated, the logic 200 uses the data structure 206 to conserve power. More specifically, the logic 200 adjusts the frequency at which the MCD 104 checks for paging signals on the PCH in accordance with the data structure 206. For example, referring to FIGS. 2 and 3, if the logic 200 determines that the current time is 1:06 AM, the logic 200 uses the data structure 206 (entry 300b) to determine that at 1:06 AM, the network activity levels are low and thus the rate at which paging signals are sent on the PCH is low. Accordingly, the logic 200 ensures that the logic 200 checks the PCH at a lowered frequency compared to times of the day when network activity levels are medium or high. The precise frequency at which the logic 200 checks the PCH may be programmed into the software 204. For example, in preferred embodiments, if the network activity level at a given time is high, the logic 200 may check the PCH for paging signals every second. If the network activity level is medium, the logic 200 may check the PCH every two seconds. If the network activity level is low, the logic 200 may check the PCH every three seconds. The scope of this disclosure is not limited to these particular frequencies. For example, in some embodiments, during periods of high network activity the logic 200 may check the PCH approximately every half second. Similarly, in such embodiments, during periods of low network activity the logic 200 may check the PCH less frequently than approximately every three seconds.

In some embodiments, network activity may be determined using not only the PCH, but also a Broadcast Control Channel (BCCH). The BCCH includes various parameters which are broadcast to the MCDs in the network 100. The MCDs must adjust themselves in accordance with these parameters in order to establish and maintain communications with the station 102. Illustrative parameters include:

| Calibration Data | |
|---|---|
| Parameter | Description |
| BS_CC_CHANS | Number of basic physical channels |
| | supporting common control channels |
| BS_AG_BLKS_RES | Number of blocks on each common |
| | control channel reserved for access |
| | grant messages |
| BS_PA_MFRMS | Number of multiframes between two |
| | transmissions of the same paging |
| | message to MSs of the same paging group |
| MS_TXPWR_MAX_CCH | Maximum Allowed Transmitted |
| | RF Power for MSs to Access the |
| | System until commanded otherwise |

Some of these parameters, such as the BS_AG_BLKS_RES and the BS_PA_MFRMS, are adjusted by the station 102 in accordance with the network activity level. For example, the BS_AG_BLKS_RES parameter ranges from “1” when a network cell has lower levels of network activity to “7” when the network cell has higher levels of network activity. Similarly, the BS_PA_MFRMS parameter ranges from “2” when the network cell has lower levels of network activity to “9” when the network cell has higher levels of network activity.

These parameters may fluctuate with time. For example, during business hours, network activity levels are high and so the BS_AG_BLKS_RES parameter may range from 5-7 and the BS_PA_MFRMS parameter may range from 7-9. During night hours (e.g., at 2:00 AM), network activity levels are low and so the BS_AG_BLKS_RES parameter may range from 1-2 and the BS_PA_MFRMS parameter may range from 2-3. During intermediate hours (e.g., just before and just after business hours), network activity levels are lower than during business hours but higher than during night hours. Thus, the parameters may have values that fall near the middle of their respective ranges.

Data associated with the BCCH may be collected by the MCDs in a manner similar to that used to gather data associated with the PCH. In preferred embodiments, the logic 200 of the MCD 104 may generate a data structure 300 such as that described above. The logic 200 may observe network activity levels using the BCCH and the PCH and may populate the data structure 300 using these observations. As with the PCH, the logic 200 may have access to BCCH rate thresholds programmed into the storage 202. These BCCH rate thresholds may be used to classify observed BCCH parameters as “HIGH,” “MEDIUM” or “LOW.” Alternatively, instead of classifying the BCCH parameters in accordance with predetermined thresholds, the values of the BCCH parameters may be entered directly into the data structure. Data structures may be generated and populated to contain BCCH information, PCH information, or combinations thereof. Once entered into the data structure, the BCCH parameters may be used in a manner similar to that with which the PCH data is used.

FIG. 4 shows a flow diagram of an illustrative method 400 used to implement the techniques described above. The method 400 comprises determining a network activity level for a predetermined period of time (block 402). As described above, determining the network activity preferably comprises monitoring the rate at which one or more parameter signals (e.g., BCCH parameter signals) broadcast by a station (e.g., a base station) are adjusted, monitoring the rate at which paging signals are sent on the PCH, or some combination thereof. Determining network activity also may comprise other monitoring techniques (e.g., the monitoring of parameters besides BCCH and/or channels besides PCH and BCCH) not specifically described herein. The method 400 also comprises generating and populating a data structure, where the data structure comprises multiple entries which cross-reference the network activity level with predetermined periods of time (block 404). For example, and as described above, one or more identifiers used to describe network activity level may be cross-referenced with time ranges with varying levels of precision (e.g., months, weeks, days, hours, minutes, seconds, milliseconds). If said predetermined period of time matches a current time, the method 400 comprises adjusting a frequency at which a calibration signal on the network is determined (block 406). The frequency preferably is adjusted in accordance with the network activity level of the data structure.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a transceiver; and
processing logic coupled to said transceiver and configured to determine an activity level of a network associated with said system and, based on said activity level, adjust a frequency with which the processing logic monitors signals broadcast by the network.

2. The system of claim 1, wherein said system comprises a device selected from the group consisting of a mobile phone, a personal digital assistant and a digital media player.

3. The system of claim 1, wherein said processing logic is configured to increase the frequency if said activity level is increased, and wherein said processing logic is configured to decrease the frequency if said activity level is decreased.

4. The system of claim 1, wherein the processor is configured to populate a data structure having an entry, the entry associates said activity level with associated time data.

5. The system of claim 4, wherein said time data comprises a range of time.

6. The system of claim 1, wherein the processing logic is configured to determine the activity level by monitoring a rate at which parameters associated with a Broadcast Control Channel (BCCH) are modified.

7. The system of claim 1, wherein the processing logic is configured to determine the activity level by monitoring a rate at which paging signals pass through a Paging Channel (PCH).

8. The system of claim 1, wherein the processing logic is configured to determine said activity level on a rolling time basis.

9. A method, comprising:
determining a network activity level for a predetermined period of time;
generating and populating a data structure, the data structure cross-references the network activity level with said predetermined period of time; and
if said predetermined period of time is associated with a current time, adjusting a frequency with which signals transmitted from a base station are monitored;
wherein adjusting said frequency comprises adjusting said frequency in accordance with said network activity level.

10. The method of claim 9, wherein said signals comprise Broadcast Control Channel (BCCH) signals.

11. The method of claim 9, wherein said signals comprise paging signals transmitted on a Paging Channel (PCH).

12. The method of claim 9 further comprising:
if said network activity level increases, increasing said frequency; and
if said network activity level decreases, decreasing said frequency.

13. The method of claim 9 further comprising expressing said predetermined period of time in terms of a unit selected from the group consisting of months, weeks, days, hours, minutes, second and units of time smaller than one second.

14. The method of claim 9, wherein determining said network activity level comprises determining said activity level on a rolling time basis.

15. A system, comprising:
means for determining an activity level of a network associated with the system, said network broadcasts signals; and
means for monitoring said signals at a frequency that is in accordance with said activity level.

16. The system of claim 15, wherein said system comprises a device selected from the group consisting of a mobile phone, a personal digital assistant and a digital media player.

17. The system of claim 15, wherein the means for monitoring is configured to increase said frequency if said activity level increases and is further configured to decrease said frequency if said activity level decreases.

18. The system of claim 15, wherein said means for determining is configured to determine said activity level on a rolling time basis.

19. The system of claim 15, wherein the system is configured to populate a data structure having an entry, the entry associates said activity level with a time period.

20. The system of claim 15, wherein the means for determining is configured to determine the activity level by monitoring a rate at which paging signals pass through a Paging Channel (PCH).
